(19) United States
(12) Patent Application Publication
(10) Pub. No.: US 2020/0339405 A1
(43) Pub. Date: Oct. 29, 2020

(54) CARTRIDGE FOR DRINK DISPENSING MACHINE

(71) Applicant: Clone Spirits, LLC, St. Louis, MO (US)

(72) Inventors: Joe H. Moore, St. Louis, MO (US); Stephen P. Lauer, St. Louis, MO (US)

(21) Appl. No.: 16/855,468

(22) Filed: Apr. 22, 2020

Related U.S. Application Data
(60) Provisional application No. 62/837,489, filed on Apr. 23, 2019.

(51) Int. Cl. B67D 1/00; A47J 31/44; A47J 31/46; B65D 85/72; C12G 3/06; B67D 1/08

(52) U.S. Cl. CPC B67D 1/0079; A47J 31/4492; A47J 31/46; B67D 2001/0812; C12G 3/06; B67D 1/0807; B65D 85/72

(57) ABSTRACT

A cartridge is disclosed for containing and dispensing a fluid. The cartridge includes an outer housing enclosing an inner volume, an output spout, a plunger, and a first rib. The plunger is positioned within the internal volume and engages with the internal diameter of the outer housing. The first rib is positioned along at least a portion of the outer housing, and includes at least one identifier. The identifier includes the presence or absence of a recess at a plurality of locations along the first rib. Movement of the plunger within the internal volume forces a fluid from the internal volume out through the output spout.

### CROSS-REFERENCE TO RELATED APPLICATIONS

The present application claims priority to U.S. Provisional Application No. 62/837,489, filed Apr. 23, 2019, titled CARTRIDGE FOR DRINK DISPENSING MACHINE, the entirety of which is hereby incorporated by reference.

### FIELD OF THE INVENTION

The present disclosure relates to a cartridge for a drink dispensing machine, and more particularly to a cartridge with a structural identifier that is recognizable by a drink dispensing machine.

### BACKGROUND OF THE INVENTION

Beverage making machines, dating back to the earliest coffee makers, generally allow users to add raw materials (e.g., coffee grounds) to the machine prior to brewing or mixing the beverage. More modern beverage making machines utilize pre-measured and pre-packaged containers for consistency and ease of use. For example, coffee makers often utilize pre-portioned coffee grounds in pre-packaged cups that are inserted directly into the coffee maker. The coffee maker then punctures the cup, pumps hot water through the cup, and allows the resulting coffee to drip into a user's mug. Other beverages makers, like soda fountains, utilize prepackaged syrups that are mixed with carbonated water upon request.

However, the contents of the pre-packaged containers are typically irrelevant to such machines. Coffee makers and soda fountains generally perform the same actions, regardless of the contents of the containers. For example, coffee makers will still puncture the container and pump hot water through it, regardless of the type of coffee grounds inside. Soda fountains similarly will merely add the syrup to carbonated water, regardless of the type or flavor of syrup. Such machines therefore have no ability or need to identify the contents of the container being used.

For this reason, few existing beverage makers are capable of making varied and specific beverages on demand. Various beverages require different ingredients, which most beverage makers are not capable of utilizing.

### SUMMARY OF THE INVENTION

In an example embodiment, a cartridge is disclosed for containing and dispensing a fluid. The cartridge includes an outer housing, a housing tip engaged with a first end of the outer housing, and a cap engaged with a second end of the outer housing. The housing tip includes an output spout. The outer housing, the housing tip, and the cap collectively enclose an internal volume. A threaded screw is provided, extending from the cap within the internal volume. A plunger is engaged with the threaded screw within the internal volume, and engages with an internal diameter of at least one of the outer housing and housing tip. A first rib is positioned along at least a portion of at least one of the outer housing and housing tip, and includes at least one identifier. The identifier includes the presence or absence of a recess at a plurality of locations along the first rib. Rotation of at least a portion of the cap causes rotation of the threaded screw, which in turn causes the plunger to move within the internal volume to force a fluid from the internal volume out through the output spout.

In an example embodiment, a cartridge is disclosed for containing and dispensing a fluid. The cartridge includes an outer housing enclosing an inner volume, an output spout, a plunger, and a first rib. The plunger is positioned within the internal volume and engages with the internal diameter of the outer housing. The first rib is positioned along at least a portion of the outer housing, and includes at least one identifier. The identifier includes the presence or absence of a recess at a plurality of locations along the first rib. Movement of the plunger within the internal volume forces a fluid from the internal volume out through the output spout.

### BRIEF DESCRIPTION OF THE DRAWINGS

FIG. 1 is a perspective view of a cartridge for a beverage maker in accordance with an example embodiment.

FIG. 2 is a perspective view of the cartridge of FIG. 1, with part of its outer housing removed to illustrate the internal components thereof, in accordance with an example embodiment.

FIGS. 3A-3F illustrate example encoding patterns for ribs of a cartridge, such as that shown in FIG. 1, according to example embodiments.

FIG. 4 is a perspective view of an example beverage maker in which the cartridge of FIG. 1 may be used, in accordance with an example embodiment.

FIG. 5 is a perspective view of the example beverage maker of FIG. 4 with its front panel opened, in accordance with an example embodiment.

FIG. 6 is a perspective view of an example cartridge receiver of the beverage maker of FIG. 4, shown with cartridges installed therein, in accordance with an example embodiment.

### DETAILED DESCRIPTION OF THE INVENTION

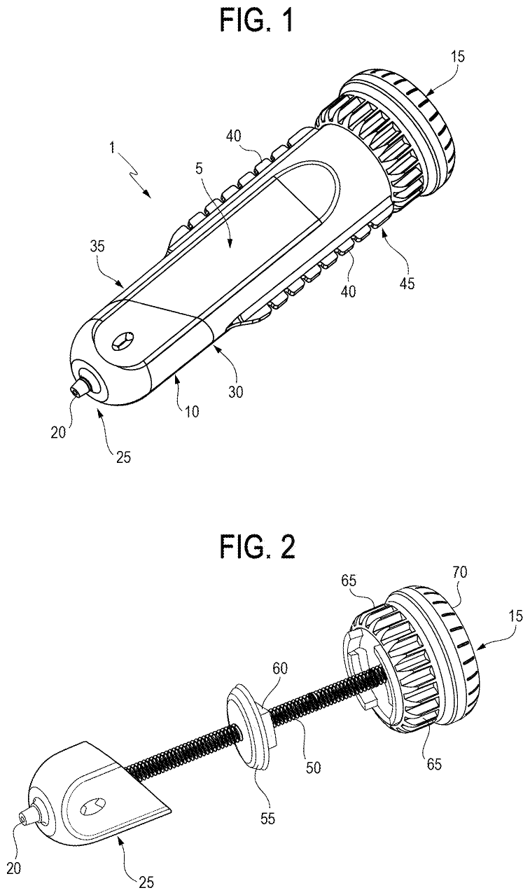

Referring to the drawings more particularly by reference numbers wherein like members refer to like parts, FIG. 1 illustrates a cartridge 1 for use in a beverage maker (not illustrated). Such a beverage maker would preferably be capable of mixing numerous different beverages utilizing the contents of one or more cartridges 1, as desired by the user. Such a beverage maker would therefore be able to determine the contents of each cartridge 1 inserted therein based on some identifying characteristic of the cartridge 1.

In the embodiment shown in FIG. 1, the cartridge 1 includes an outer housing 5, a housing tip 10, and a cap 15. The housing tip 10 includes an output spout 20 at a distal end 25 of the housing tip 10. A proximal end 30 of the housing tip 10 abuts and engages with the distal end 35 of the outer housing 5. Together, housing tip 10 and outer housing 5 generally enclose an inner volume for storing a fluid. It is noted that FIG. 1 illustrates the proximal end 30 of the housing tip 10 and the distal end 35 of the outer housing 5 as being similarly angled such that they abut and engage one. However, it will be understood that other shapes may be utilized, so long as suitable engagement occurs. Further, more or fewer pieces than the outer housing 5 and housing tip 10 may be used to enclose the inner volume.

One or more ribs 40 may extend along at least part of the outer housing 5 between a proximal end 45 thereof and the distal end 35. It will be understood that such one or more ribs 40 may extend entirely or partly along the outer housing 5, or may extend onto the housing tip 10 or the like. The function and structure of the ribs 40 will be discussed in greater detail below.

At the proximal end 45 of the outer housing 5, the cap 15 completes the enclosure of the inner volume otherwise contained by the outer housing 5 and the housing tip 10. The cap 15 may engage with the outer housing 5 by any known structure, such as via a threaded screw structure, a snap structure, or the like.

FIG. 2 illustrates the cartridge 1 of FIG. 1 with the outer housing 5 removed to expose additional structure. As can be seen, a threaded rod or screw 50 extending from the cap 15 toward the output spout 20 of the housing tip 10 within the inner volume. A plunger 55 is positioned in threading engagement with the screw 50, along with a nut 60. Plunger 55 preferable engages with the inner diameter of the outer housing 5 and/or the housing tip 10, as appropriate. Rotation of at least a portion of the cap 15 causes the screw 50 to rotate as well. Rotation of the screw 50 in turn causes the plunger 55 to move axially along the screw 50, either toward or away from the output spout 20. In doing so, fluid contents positioned within the inner volume between the plunger 55 and the output spout 20 are forced out through the output spout 20.

As is further shown in FIG. 2, the cap 15 may include at least one radially extending ridge 65. The cap 15 may also include a knob end portion 70. When the cartridge 1 is installed in a beverage machine (not shown), the beverage machine dispense fluid from the cartridge 1 by rotating at least a portion of the cap 15. The beverage machine may cause rotation of the cap 15 by engaging the at least one radially extending ridge 65 with a corresponding gear or other structure (not shown), as would be understood in the art. Rotation of the gear would thereby causes rotation of the cap 15.

In a preferred embodiment, the screw 50 includes threads with a low angle of inclination such that a single rotation of the cap 15 results in a low volume of fluid output from the output spout 20. For example, one rotation of the cap 15 may result in the output of approximately 0.05-ml of fluid from the output spout 20. This structure allows for precise control over the volume of fluid output from the cartridge 1.

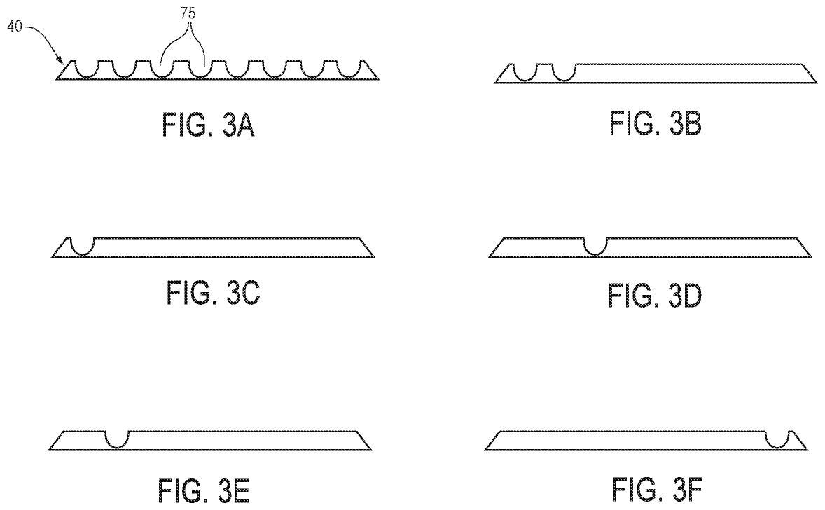

As noted above, a beverage maker that is capable of making various drinks using the contents of one or more interchangeable cartridges 1 would be capable of determining the contents of each cartridge 1 engaged therewith. The one or more ribs 40 of cartridge 1 are utilized for this purpose. Each rib 40 includes one or more recesses 75, which can be detected by the beverage maker. FIGS. 3A through 3F illustrate example ribs 40. As shown, each rib 40 may include a spot for up to eight recesses 75. The presence or absence of a recess 75 may equate to a “0” or “1” in binary. With eight spaces as shown, two hundred and fifty six different sequences are possible. Each sequence may correspond to one type of fluid that could be contained within the cartridge 1. Upon insertion into the beverage maker, the beverage maker may detect the presence or absence of these recesses 75. It may then cross-reference the detected sequence of recesses 75 (or the absences thereof) with a simple database in its onboard memory to determine the contents of the cartridge 1.

As will be understood, more or fewer spots for recesses 75 may be utilize along each rib 40. Further, rather than detecting the presence or absence of a recess 75 (i.e., binary), the beverage maker may detect the size and shape of one or more recesses 75 to determine the contents of the associated cartridge 1. Various methods of detecting the presence, absence, size and/or shape of the recesses may be used, such as optical methods, physical methods, or the like as would be understood.

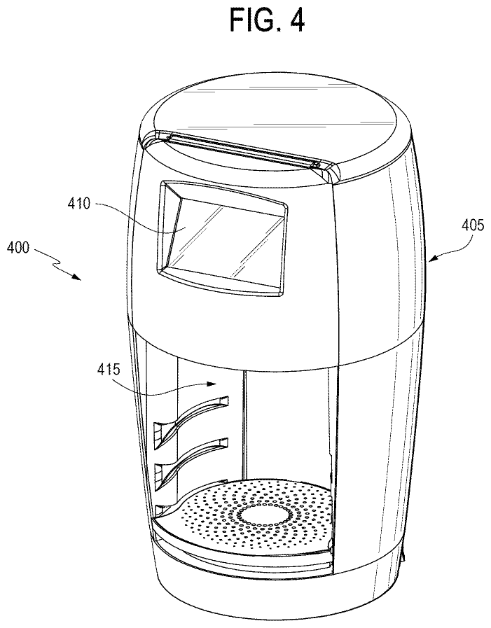

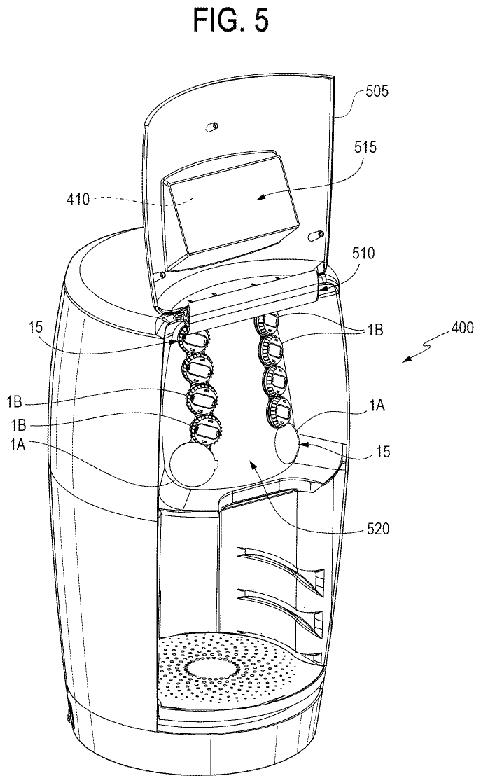

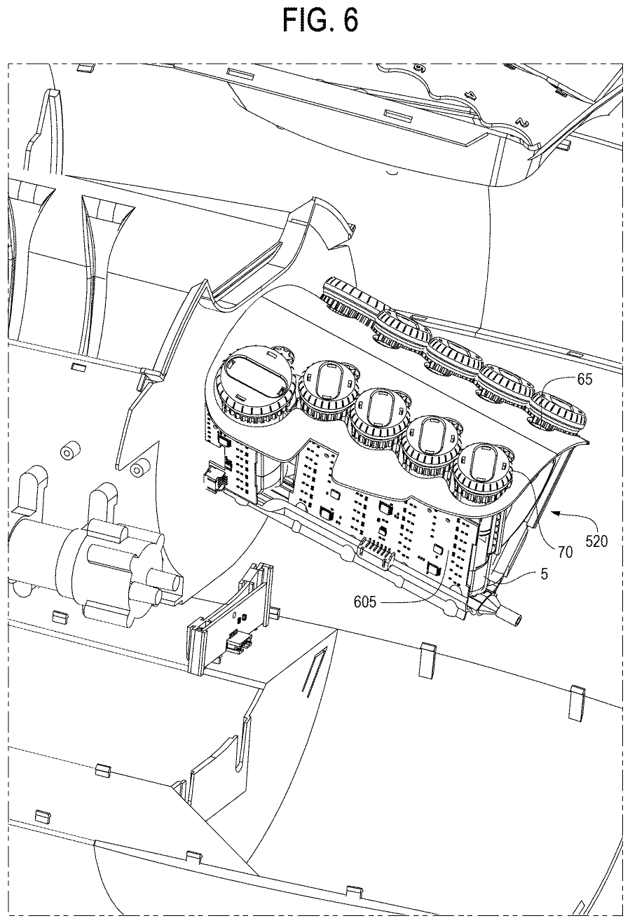

FIG. 4 illustrates an example beverage maker 400 that may be used with one or more cartridges 1 (discussed above). The beverage maker 400 includes an outer housing 405, an interface screen 410, and a beverage container receiving portion 415. FIG. 5 illustrates the beverage maker 400 with its front panel 505 opened upwardly about a hinge 510. On the rear of the front panel 505, an enclosure 515 for the interface screen 410 and its associated electronics can be seen. Further visible is a cartridge receiver 520 that receives cartridges 1. Only knob end portions 70 of the illustrated cartridges 1 are visible, with the remainder of each cartridge 1 having been received by a slot in the cartridge receiver 50. FIG. 5 illustrates several sizes of cartridges 1, such as larger cartridges 1A and smaller cartridges 1B. As will be understood, certain flavoring agents, such as sweetener or vanilla, are used much more often in various recipes, or in larger amounts in a given recipe. Thus, larger cartridges 1A may contain more commonly used flavoring agents, while smaller cartridges 1B may include respective flavoring agents that are used less frequently. The flavoring agents are dispensed for mixing with a base beverage, according to a recipe. The base beverage may be separately contained in a reservoir or the like, as would be understood. The base beverage may be a generally flavorless liquid such as vodka or the like, although it will be understood that flavorless liquids are not required. Further, more or fewer cartridges 1, whether large cartridges 1A or small cartridges 1B, may be receivable by the cartridge receiver 520 in various positions and orientations.

FIG. 6 illustrates an exploded view of the example beverage maker 400, in which the cartridge receiver 520 has been isolated. As can be seen, when installed in a slot of the cartridge receiver 520, each cartridge 1 is positioned adjacent a circuit board 605. FIG. 6 illustrates a single circuit board 605 adjacent four small cartridges 1B on each side of the cartridge receiver 520, and a separate circuit board 605 adjacent each larger cartridge 1A. However, more or fewer circuit boards 605 could be used. Circuit boards 605 contain circuitry and/or other hardware/software to identify the recesses 75 (or the lack thereof) on the ribs 40 of each cartridge 1. As noted above, such identification may occur via any known method, including optical methods, physical methods, or the like as would be understood. Further, such circuitry, hardware, or software may reside elsewhere within the beverage maker 400.

Upon insertion of a cartridge 1 into the cartridge receiver 520, the beverage maker 400 may read the encoded identifier of the contents of the cartridge from the ribs 40. The beverage maker 400 may then cross reference the identifier with a database stored in its memory, as would be understood in the art, to determine the contents of the cartridge 1. Based on the collection of cartridges 1 in the cartridge receiver 520, the beverage maker 400 may provide options to the user via the interface screen 410 for beverages that can be created with the current list of ingredients. Such a drink list and associated recipes may similarly be stored in the memory of the beverage maker 400. A user may then select one such beverage from the interface screen 410.

The beverage maker 400 then causes dispensing of appropriate volumes of appropriate ingredients based on the recipe for the selected beverage. To do so, it determines which cartridge(s) 1 contain the needed ingredients, and causes actuation of at least a portion of the cap 15 of the appropriate cartridge(s) 1. In an example embodiment, the cartridge receiver may include one or more motors capable of causing rotation of the cap 15 by engaging the at least one radially extending ridge 65, as would be understood in the art. As a non-limiting example, a gear or the like that engages with the ridge(s) 65 of a cartridge may be rotated by a motor, which thereby causes rotation of the cap 15. Rotation of the cap 15 causes rotation of the screw 50, thereby forcing the plunger 55 to push a predetermined amount of fluid from the selected cartridge 1.

Various ingredients may be dispensed simultaneously, or may be dispensed one at a time. Once all ingredients for the selected recipe have been dispensed from their cartridges 1, the ingredients may be mixed together. This may occur within the beverage maker 400, or may occur by allowing all of the ingredients to flow into and thereby mix in a glass or other beverage container.

Once a cartridge 1 is empty, or if a user decides that other ingredients are desirable, cartridges 1 may be removed from the cartridge receiver 520 and replaced with different cartridges having any desired ingredient.

Thus, there has been shown and described a cartridge with its contents encoded in its physical structure. As is evident from the foregoing description, certain aspects of the present inventions are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A cartridge for containing and dispensing a fluid, the cartridge comprising:
an outer housing;
a housing tip engaged with a first end of the outer housing, said housing tip including an output spout;
a cap engaged with a second end of the outer housing, wherein said outer housing, said housing tip, and said cap collectively enclose an internal volume;
a threaded screw extending from the cap within the internal volume;
a plunger engaged with the threaded screw within the internal volume, the plunger engaging with an internal diameter of at least one of the outer housing and housing tip;
a first rib positioned along at least a portion of at least one of the outer housing and housing tip, the first rib including at least one identifier, wherein the identifier includes the presence or absence of a recess at a plurality of locations along the first rib; and
wherein rotation of at least a portion of the cap causes rotation of the threaded screw, which in turn causes the plunger to move within the internal volume to force a fluid from the internal volume out through the output spout.

2. The cartridge of claim 1 wherein the housing tip and outer housing are integrally formed.

3. The cartridge of claim 1 further including a nut engaged with the threaded screw and positioned on a side of the plunger opposite the housing tip.

4. The cartridge of claim 1 further including a second rib including an identifier.

5. The cartridge of claim 4 wherein the identifier on the second rib is the same as the identifier on the first rib.

6. The cartridge of claim 4 wherein the identifier on the second rib is different from the identifier on the first rib.

7. The cartridge of claim 1 wherein the cap includes at least one or more radially extending ridges.

8. A cartridge for containing and dispensing a fluid, the cartridge comprising:
an outer housing enclosing an inner volume;
an output spout;
a plunger positioned within the internal volume, the plunger engaging with an internal diameter of the outer housing;
a first rib positioned along at least a portion of the outer housing, the first rib including at least one identifier, wherein the identifier includes the presence or absence of a recess at a plurality of locations along the first rib; and
wherein movement of the plunger within the internal volume forces a fluid from the internal volume out through the output spout.
